(19) United States
(12) Patent Application Publication
(10) Pub. No.: US 2003/0079009 A1
(43) Pub. Date: Apr. 24, 2003

(54) Gatekeeper apparatus and communication system

(75) Inventor: Tatsuo Takaoka, Kanagawa (JP)

Correspondence Address: Ivan S. Kavrukov, Cooper & Dunham LLP, 1185 Avenue of the Americas, New York, NY, 10036, US

(73) Assignee: Ricoh Company, Ltd.

(21) Appl. No.: 10/236,217

(22) Filed: Sep. 6, 2002

(30) Foreign Application Priority Data
Sep. 10, 2001 (JP) 2001-273376

(51) Int. Cl. G06F 15/16; G06F 11/00; H04L 1/00

(52) U.S. Cl. 709/223; 370/229; 709/235; 709/240

(57) ABSTRACT

A gatekeeper apparatus for performing call control for a plurality of terminal apparatuses is provided, which gatekeeper apparatus includes: a storing part for storing a terminal management table; a receiving part for receiving a call connection request from a terminal apparatus; an estimation part for estimating network load by using the terminal management table; and a decision part for determining whether the call connection request is accepted on the basis of the network load.

### BACKGROUND OF THE INVENTION

1. Field of the Invention

The present invention relates to a gatekeeper apparatus, which complies with TTC standard JT-H323 (to be referred to as JT-H323 hereinafter), that performs call control for a plurality of terminal apparatuses that use a packet communication network, and a communication system, which complies with JT-H323, including a plurality of terminal apparatuses that use a packet communication network and a gatekeeper apparatus for performing call control for the terminal apparatuses.

2. Description of the Related Art

As a communication system using a packet communication network such as the Internet, there is one that complies with JT-H323. The TTC standard JT-H323 is intended for defining requirements of a multimedia communication system in a packet network in which service quality is not necessarily assured. The packet network in JT-H323 includes a local area network, a corporate area network, a metropolitan area network, an intranet, a network in which networks including the Internet are interconnected, and the like. In addition, JT-H323 includes point to point connection on GSTN or ISDN, or packet type transmission such as PPP by dialup connection. In addition, the network may include a single segment, or may have a complicated topology in which a plurality of network segments are interconnected.

As an example of the communication system of JT-H323, there is a communication system in which call control between terminal apparatuses included in the network is performed by using a gatekeeper apparatus.

The gatekeeper apparatus is defined to be an endpoint for providing a real-time bidirectional communication between JT-H323 terminal on a packet network and a TTC terminal on a circuit switching network, or between the JT-H323 terminal and another JT-H323 gateway. The TTC terminal is defined to include, a JT-H310 (applying JT-H320 to B-ISDN) terminal, a JT-H320 (ISDN) terminal, a JT-H321 (ATM) terminal, a JT-H322 (service quality (QoS) assured type LAN) terminal, a JT-H324 (GSTN) terminal, a JT-H324M (mobile communication) terminal and an ITU-T recommendation V.70 (DSVD) terminal.

“JT-H323 terminal” is a communication terminal having a communication function complying with. TTC standard JT-H323. In this specification, terminals and other apparatuses to which an ITU-T recommendation number is attached mean terminals and other apparatuses having a communication function complying with corresponding TTC standards or ITU-T recommendations.

### SUMMARY OF THE INVENTION

An object of the present invention is to provide a gatekeeper apparatus that can process communications on the network smoothly, and a communication system including the gatekeeper apparatus.

The above object is achieved by a gatekeeper apparatus for performing call control for a plurality of terminal apparatuses that use a packet communication network. In the gatekeeper apparatus, priority information is set to at least one of the plurality of terminal apparatuses, and the gatekeeper apparatus processes a call connection request from a terminal apparatus according to the priority information.

According to this invention, when priority is set to a terminal apparatus that sends a call connection request, the call connection request may be allowed. Thus, proper call connection operation can be realized according to types of terminal apparatuses.

The above object is also achieved by a gatekeeper apparatus for performing call control for a plurality of terminal apparatuses that use a packet communication network. In the gatekeeper apparatus, order of priority is set to the plurality of terminal apparatuses, and the gatekeeper apparatus processes a call connection request from a terminal apparatus according to the order of priority.

According to this invention, for example, when priority for a terminal apparatus that sends a call connection request is set to be higher than other terminal apparatuses that are operating, the call connection request may be allowed. Thus, proper call connection operation can be realized according to types of terminal apparatuses.

In the above-mentioned gatekeeper apparatus, the gatekeeper apparatus estimates network load, and processes the call connection request according to the estimated network load and the order of priority or the priority information.

The above object is achieved by a gatekeeper apparatus for performing call control for a plurality of terminal apparatuses that use a packet communication network, the gatekeeper apparatus includes: a storing part for storing a terminal management table; a receiving part for receiving a call connection request from a terminal apparatus; an estimation part for estimating network load by using the terminal management table; a decision part for determining whether the call connection request is accepted on the basis of the network load.

According to this invention, the call connection request can be accepted only when allowance for network capacity is enough. Therefore, excessive network load can be avoided so that communication that is already being performed is not disturbed or interrupted.

In the gatekeeper apparatus, the decision part determines whether the call connection request is accepted on the basis of priority information when there is not enough network capacity remaining, the priority information being included in the terminal management table.

In addition, in the gatekeeper apparatus, the decision part determines whether the call connection request is accepted on the basis of order of priority in addition to the network load, the order of priority being included in the terminal management table.

### BRIEF DESCRIPTION OF THE DRAWINGS

Other objects, features and advantages of the present invention will become more apparent from the following detailed description when read in conjunction with the accompanying drawings, in which:

FIG. 1 shows an example of a communication system according to an embodiment of the present invention;

FIG. 2 shows a block diagram of an example of T.38 terminal apparatuses (TA1-TAn, TB1-TBn);

FIG. 3 shows a timing chart of an example of a data transmission procedure between T.38 terminal apparatuses;

FIG. 4 shows an example of a procedure for performing call control of a terminal apparatus by using a gatekeeper apparatus;

FIG. 5A shows an example of a terminal management table;

FIG. 5B shows an example of terminal information;

FIG. 5C shows another example of terminal information;

FIG. 6 shows a block diagram of an example of the gatekeeper apparatus;

FIG. 7 shows a flowchart of an example of a procedure of the gatekeeper apparatus when it receives a call connection request from a terminal apparatus;

FIG. 8 shows a flowchart of another example of a procedure of the gatekeeper apparatus when it receives a call connection request from a terminal apparatus.

### DETAILED DESCRIPTION OF THE PREFERRED EMBODIMENTS

In the following, embodiments of the present invention will be described in detail.

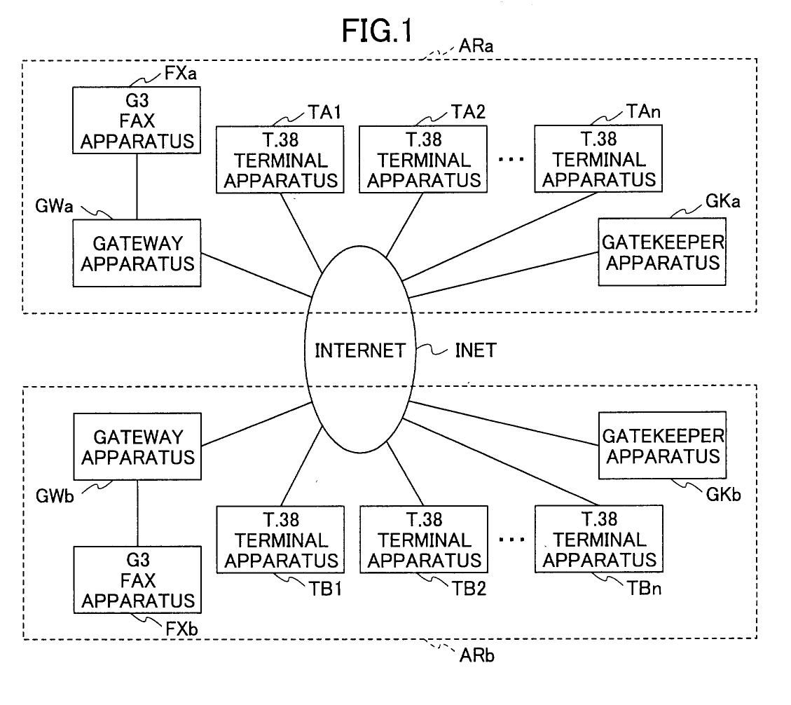

FIG. 1 shows an example of a communication system according to an embodiment of the present invention. This communication system complies with JT-H323, uses the Internet INET as a packet communication network, and includes various terminal apparatuses provided in two areas ARa and Arb.

In the areas ARa and Arb, terminal apparatuses, gateway apparatuses GWa and GWb as JT-H323 gateways, and gatekeeper apparatuses GKa and GKb are included. The terminal apparatuses include group 3 facsimile apparatuses FXa and FXb as TTC terminals, and T.38 terminal apparatuses TA1-TAn and TB1-TBn as JT-H323 terminal apparatuses.

The T.38 terminal apparatus is a terminal apparatus that complies with ITU-T recommendation T.38, and is for realizing real-time communication of an ITUT recommendation T.30 terminal apparatus (group 3 facsimile apparatus) by using a packet communication network. In the T.38 terminal apparatus, two communication types are defined. In one communication type, a T.38 terminal apparatus directly communicates with another T.38 terminal apparatus. In another communication type, the T.38 terminal apparatus communicates with a group 3 facsimile apparatus that is connected to a PSTN (public switched telephone network) via a gateway apparatus.

That is, in this case, the gateway apparatuses GWa and GWb include a function for realizing communication between the T.38 terminal apparatuses TA1-TAn, TB1-TBn and the group 3 facsimile apparatuses FXa and FXb.

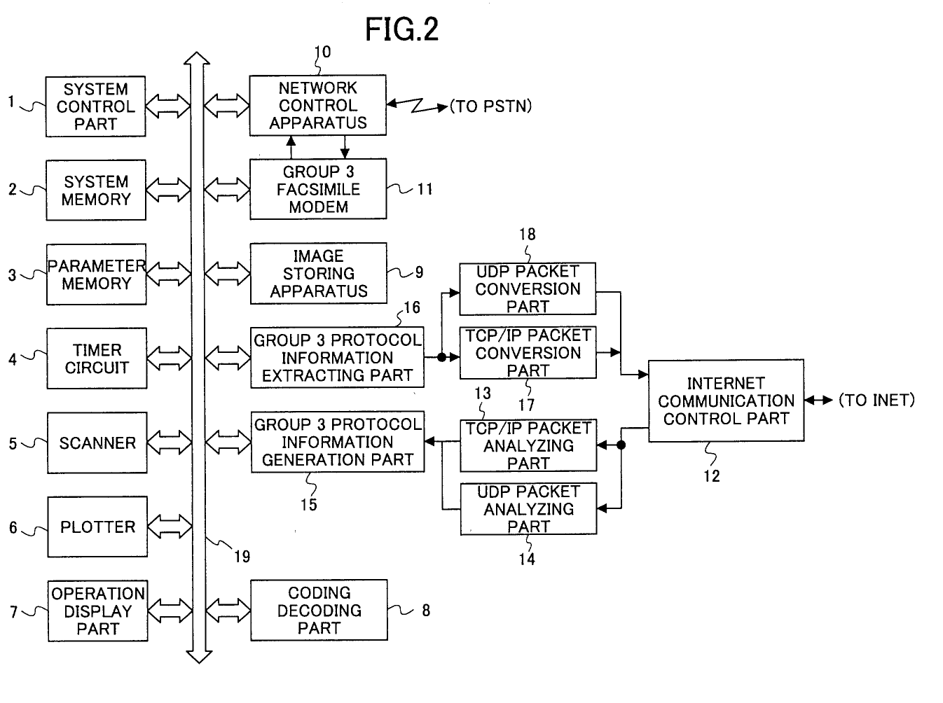

FIG. 2 shows a block diagram of an example of a T.38 terminal apparatus (TA1-TAn, TB1-TBn).

In the figure, a system control part 1 performs various control processes such as control processes for each part of the T.38 terminal apparatus, facsimile transmission control procedure processes (ITU-T recommendation T.38 procedure) and real-time transmission control procedure (ITU-T recommendation T.38 procedure) processes. A system memory 2 stores a control process program executed by the system control part 1 and data necessary for executing the process program, and provides a work area for the system control part 1. A parameter memory 3 stores various items of information intrinsic for the T.38 terminal apparatus, and a timer circuit 4 outputs current time information.

A scanner 5 reads a document image at a predetermined resolution. A plotter 6 outputs an image at a predetermined resolution. An operation display part 7 is used for operating the facsimile apparatus, and includes various operation keys and various displays.

A coding-decoding part 8 compresses image signals by coding, and decodes the compressed image information to the original image signals. In this case, the coding-decoding part 8 is mainly used for detecting errors when receiving image information. An image storing apparatus 9 is used for storing many items of compressed image information.

A network control apparatus 10 is used for connecting the T.38 terminal apparatus to the PSTN, and includes an automatic call originating and receiving function. A group 3 facsimile modem 11 is used for realizing a modem function of the group 3 facsimile, and includes a low speed modem function (V.21 modem) for transmitting and receiving transmission procedure signals, and a high speed modem function for transmitting and receiving mainly image information (V.17 modem, V.34 modem, V.29 modem, and V.27 ter modem).

An Internet communication control part 12 is used for connecting the T.38 terminal apparatus to the Internet INET, and for transmitting and receiving various data via the Internet INET. A TCP/IP packet analyzing part 13, in a TCP mode, analyzes TCP/IP packets received by the Internet communication control part 12 to extract received information. An UDP packet analyzing part 14, in a UDP mode, analyzes UDP packets received by the Internet communication control part 12 to extract received information.

A group 3 protocol information generation part 15, in a real-time transmission procedure, converts received information output from the TCP/IP packet analyzing part 13 into corresponding group 3 transmission procedure signal information in the TCP mode, and converts received information output from the UDP packet analyzing part 14 into corresponding group 3 transmission procedure signal information.

A group 3 protocol information extracting part 16, in a real-time transmission procedure, extracts group 3 facsimile transmission procedure information to be sent. A TCP/IP packet conversion part 17 converts the group 3 facsimile transmission procedure information output from the group 3 protocol information extracting part 16 into TCP/IP packet data in the TCP mode. The output data are applied to the Internet communication control part 12. An UDP packet conversion part 18 converts the group 3 facsimile transmission procedure information output from the group 3 protocol information extracting part 16 into UDP packet data in the UDP mode. The output data are applied to the Internet communication control part 12.

The system control part 1, the system memory 2, the parameter memory 3, the timer circuit 4, the scanner 5, the plotter 6, the operation display part 7, the coding decoding part 8, the image storing apparatus 9, the network control apparatus 10, the group 3 facsimile modem 11, the group 3 protocol information generation part 15, and the group 3 protocol information extracting part 16 are connected to an internal bus 19, so that data are sent and received by these parts via the internal bus 19. Data are sent and received directly between the network control apparatus 10 and the group 3 facsimile modem 11.

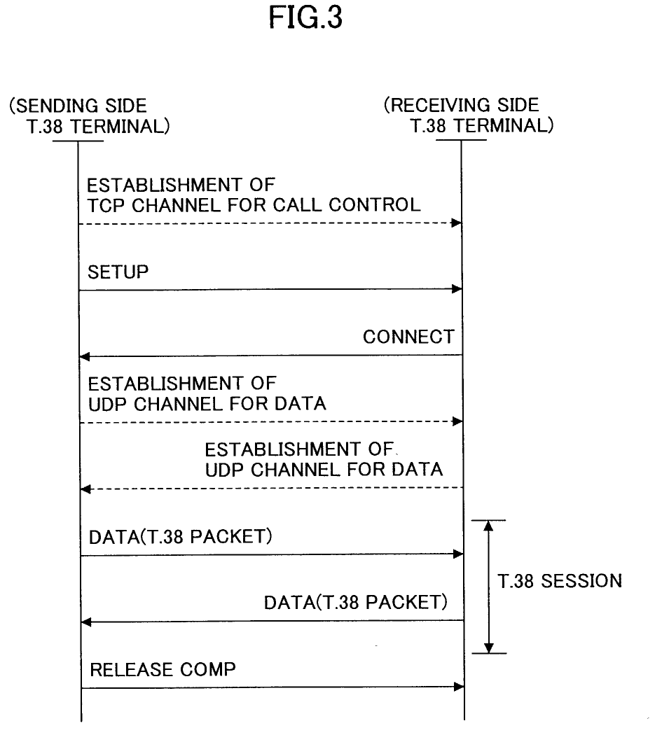

FIG. 3 shows an example of a data transmission procedure between the T.38 terminal apparatuses.

First, a sending side T.38 terminal apparatus established a TCP channel for performing call control for a receiving side T.38 terminal apparatus. Next, the sending side T.38 terminal apparatus sends a packet SETUP for call connection to the receiving side T.38 terminal apparatus.

When the receiving side T.38 terminal apparatus receives the packet SETUP from the sending side T.38 terminal apparatus, the receiving side T.38 terminal apparatus returns a packet CONNECT to the sending side T.38 terminal apparatus, so that a call is established between the sending side T.38 terminal apparatus and the receiving side T.38 terminal apparatus. By exchanging the packet SETUP and the packet CONNECT, a mode (TCP mode or UDP mode) and a port number to be used are set.

Next, the sending side T.38 terminal apparatus establishes a UDP channel for transmitting data from the sending side to the receiving side, and the receiving side T.38 terminal apparatus establishes a UDP channel for transmitting data from the receiving side to the sending side. After that, data exchange of a T.38 session according to a T.38 procedure is started between the sending side T.38 terminal apparatus and the receiving apparatus T.38 terminal apparatus by using the established two UDP channels for data, so that image information communication operation is performed.

When image information communication ends, the sending side T.38 terminal apparatus sends a packet RELEASE COMP to the receiving side T.38 terminal apparatus, so that data communication operation ends between the sending side T.38 terminal apparatus and the receiving side T.38 terminal apparatus.

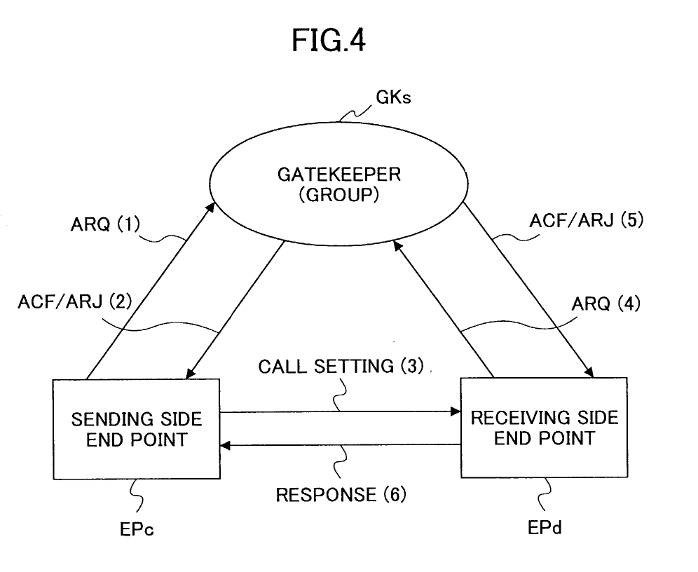

FIG. 4 shows an example of a procedure for performing call control for terminal apparatuses by using a gatekeeper apparatus (refer to FIG. 10 in the TTC standard JT-H323). First, a sending side end point (a sending side terminal apparatus) EPc sends a call connection request (call origination) ARQ to the gatekeeper apparatus (group) GKs. The gatekeeper apparatus (group) GKs sends a response ACF to the sending side end point EPc when the gatekeeper apparatus (group) GKs can accept the call connection request. When the gatekeeper apparatus (group) GKs cannot accept the call connection request, the gatekeeper apparatus (group) sends a response ARJ to the sending side end point EPc.

When the sending side end point EPc receives the response ACF from the gatekeeper apparatus (group), the sending side end point EPc sends a predetermined call setting signal to the receiving side end point EPd that is a communication target.

When the receiving side end point EPd receives the call setting signal, the receiving side end point EPd sends a call connection request (incoming call) ARQ to the gatekeeper apparatus (group) GKs. When the gatekeeper apparatus (group) GKs can accept the call connection request (incoming call), the gatekeeper apparatus (group) GKs sends a response ACF to the receiving side end point EPd. When the gatekeeper apparatus (group) GKs cannot accept the call connection request (incoming call), the gatekeeper apparatus (group) GKs sends a response ARJ to the receiving side end point EPd.

When the receiving side end point EPd receives the response ACF from the gatekeeper apparatus (group) GKs, the receiving side end point EPd sends a predetermined response signal (acknowledgement) to the sending side end point EPc.

As a result, a communication path is established between the sending side end point EPc and the receiving side end point EPd, so that communication between the sending side end point EPc and the receiving side end point EPd is performed.

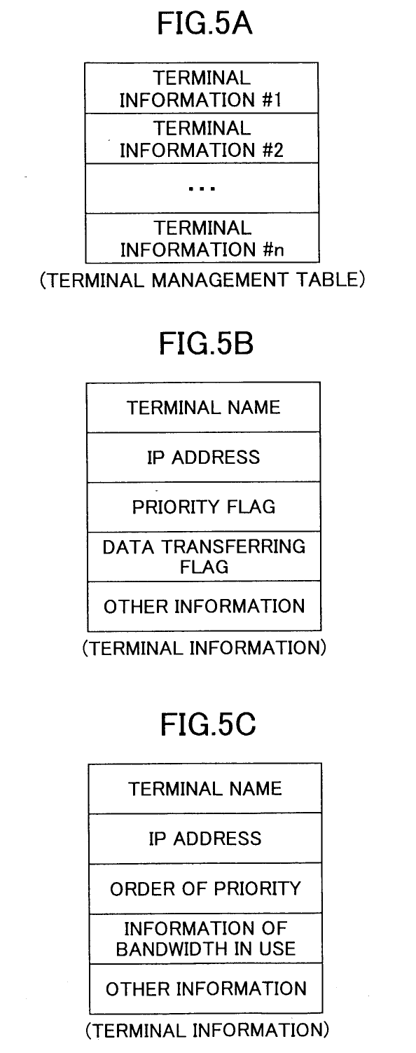

In the present embodiment, the gatekeeper apparatus GK includes a terminal management table shown in FIG. 5A, and determines whether it is allowed to accept the call connection request from the sending side end point EPc. The terminal management table stores terminal information for each registered terminal, for example, for a case shown in FIG. 1, terminal information is stored for each of the T.38 terminal apparatuses and gateway apparatuses. As shown in FIG. 5B, the terminal information includes a terminal name indicating a terminal, an IP address assigned to the terminal, a priority flag indicating whether the terminal has a high priority, a data transmitting flag that is set while the terminal is performing data communication, and other items of information.

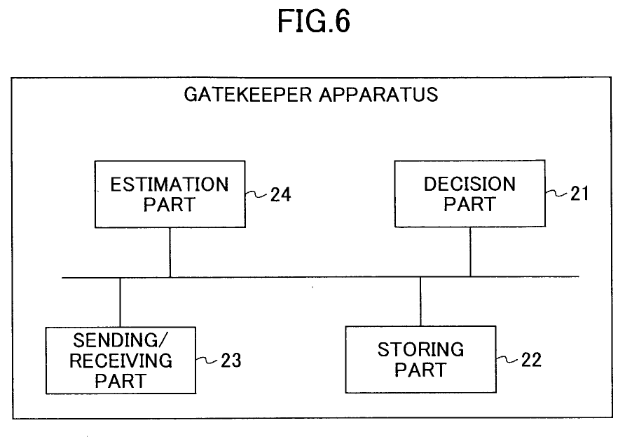

FIG. 6 shows a block diagram of an example of the gatekeeper apparatus GK. The gatekeeper apparatus GK includes a decision part 21 for deciding whether the call connection request is accepted, a storing part for storing the terminal management table, a sending/receiving part 23 for sending and receiving various signals, and an estimation part for estimating network load. The gatekeeper apparatus can be implemented by using a computer and a program. When using a computer as the gatekeeper apparatus, the decision part 21 and the estimation part 24 may correspond to a CPU, and the storing part 22 may correspond to a memory or a hard disk, and the sending/receiving part may correspond to a communication device in the computer.

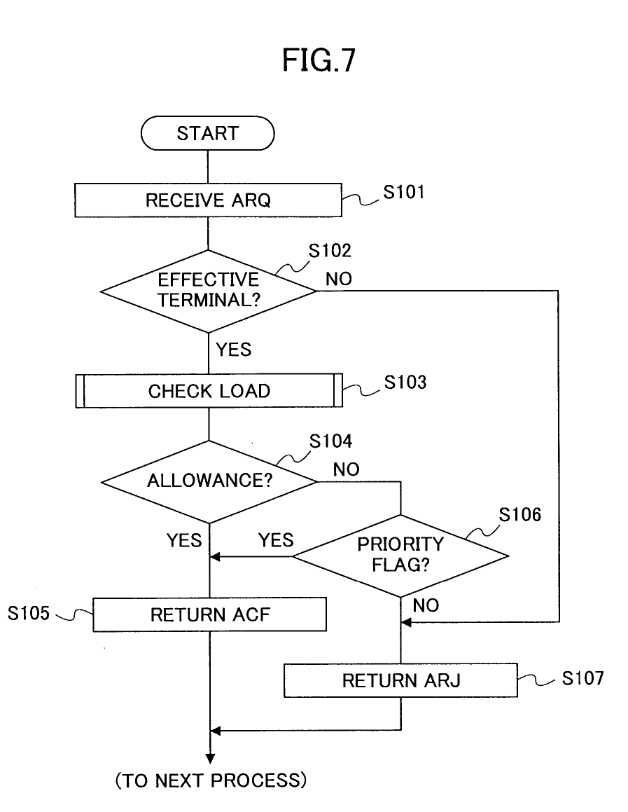

When the gatekeeper apparatus GK receives the call connection request from a terminal apparatus, it performs processes shown in FIG. 7 so as to determine whether it accepts the call connection request.

That is, when the gatekeeper apparatus GK receives a call connection request (sending side) ARQ from a terminal apparatus (sending side end point) in step 101, the gatekeeper apparatus GK determines whether the sending side end point is an effective terminal that is registered in step 102 (decision 102). If the result of the decision is YES, the gatekeeper apparatus GK determines network load at that time in step 103. For determining the network load in step 103, the number of terminals for which the data transferring flag is set is determined, and the network load is estimated from the number.

Next, it is determined whether there remains an allowance of network bandwidth by using the network load estimated in step 103 (decision 104). When the result of decision 104 is YES, the response ACF is sent to the sending end point at that time in step 105, and further processes are performed.

When the result of decision 104 is NO, it is determined whether the priority flag is set for the terminal of the send side end point (decision 106). When the result of decision 106 is YES, the process goes to step 105, and the response ACF is sent to the sending end point at that time, and further processes are performed.

When the result of decision 106 is No, the response ARJ is sent to the sending side end point at that time in step 107, and further processes are performed. When the result of decision 102 is No, the process moves to step 107, and the response ARJ is sent to the sending side end point at that time and further processes are performed.

As a result, according to this embodiment, when receiving the call connection request from the terminal apparatus, the gatekeeper apparatus GK determines whether the call connection request is allowed according to the network load at that time. Therefore, excessive network load can be avoided so that communication that is being performed is not obstructed.

In addition, since call connection is allowed for a request from a terminal in which the priority flag is set, appropriate call connection operation can be performed according to types of terminal apparatuses. Especially, the T.38 terminal apparatus uses image information having a relatively large amount of data as transmission information, and it also can perform high speed data transfer by using burst transfer mode in the UDP transfer mode. Therefore, it can be expected that call control operation by the gatekeeper apparatus GK has a large effect on network operation.

Although the network load is estimated according to the number of terminals that are performing data communication in the above-mentioned embodiment, the network load can also be estimated by monitoring bandwidths in use for terminals that are performing data communication and summing bandwidths for all terminals that are performing data communication.

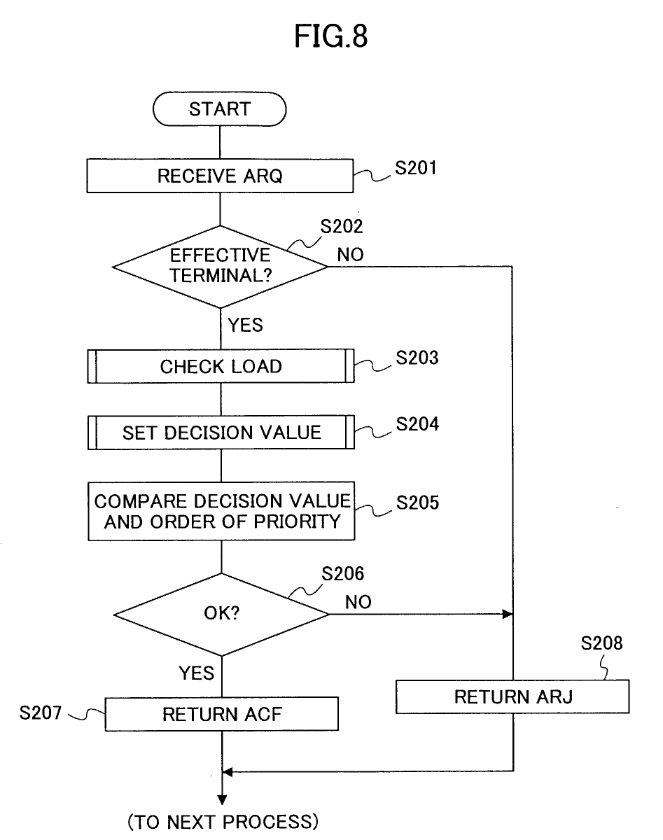

In such a case, for example, as shown in FIG. 5C, information for bandwidth that is being used is stored for each terminal information. In addition, order of priority is registered instead of the priority flag. FIG. 8 shows an example of a process of the gatekeeper apparatus GK when it receives the call connection request from a terminal apparatus in this case.

When the gatekeeper apparatus GK receives a call connection request (sending side) ARQ from a terminal apparatus (sending side end point) in step 201, the gatekeeper apparatus GK determines whether the sending side end point is an effective terminal that is registered (decision 202). When the result of decision 202 is YES, the gatekeeper apparatus GK determines network load at the time in step 203. In this determining process of the network load, total sum of bandwidths in use for all terminals is calculated by using the terminal management table, and the network load is estimated from the total sum.

A decision value is set on the basis of the network load in step 204. For example, the decision value represents that there remains an allowance of network capacity even if the requesting terminal is put in use, or, represents an excessive amount of bandwidth or a value corresponding to the excessive amount in use when there remains no allowance.

Then, it is determined whether call connection is accepted by comparing the order of priority and the decision value set in step 204 (decision 206). For example, if the terminal apparatus that requests call connection has a higher priority than other terminal apparatuses in use, the call connection request may be accepted even if there does not remain enough allowance or even if an excessive amount in use is large. On the other hand, if the terminal apparatus that requests call connection has a priority lower than that of a terminal apparatus that is operating, the call connection request may be accepted only when there remains enough network capacity.

When the result of decision 206 is YES, the response ACF is sent to the sending side endpoint in step 207, and further processes are performed.

When the result of decision 206 is No, the response ARJ is sent to the sending side endpoint in step 208, and further processes are performed. When the result of decision 202 is No, the process moves to step 208, and the response ARJ is sent to the sending side endpoint, and further processes are performed.

As mentioned above, since it is determined whether call connection is allowed according to the estimated network load and the order of priority set in the terminal information, proper call connection operation is available according to the types of terminal apparatuses.

As mentioned above, according to the present invention, when the gatekeeper apparatus receives a call connection request from the terminal apparatus, the gatekeeper apparatus determines whether it accepts the call connection request according to the network load at the time. Therefore, the network load becoming so large so that communication that is already being performed is disturbed can be avoided.

In addition, the call connection request is accepted for a request from a terminal apparatus in which the priority flag is set, and proper call connection operation becomes available according to types of terminal apparatuses.

Further, since the gatekeeper apparatus determines whether call connection is allowed according to the estimated network load and the order of priority that is set in the terminal information, proper call connection operation becomes available according to types of terminal apparatuses.

The present invention is not limited to the specifically disclosed embodiments, and variations and modifications may be made without departing from the scope of the present invention.

What is claimed is:

1. A gatekeeper apparatus for performing call control for a plurality of terminal apparatuses that use a packet communication network, wherein:
priority information is set to at least one of said plurality of terminal apparatuses, and said gatekeeper apparatus processes a call connection request from a terminal apparatus according to said priority information.

2. The gatekeeper apparatus as claimed in claim 1, wherein said gatekeeper apparatus estimates network load, and processes said call connection request according to the estimated network load.

3. The gatekeeper apparatus as claimed in claim 2, wherein said network load is estimated on the basis of a number of terminal apparatuses that are operating.

4. The gatekeeper apparatus as claimed in claim 2, wherein said network load is estimated on the basis of a total amount of bandwidth used by terminal apparatuses that are operating.

5. A gatekeeper apparatus for performing call control for a plurality of terminal apparatuses that use a packet communication network, wherein:
order of priority is set to said plurality of terminal apparatuses, and said gatekeeper apparatus processes a call connection request from a terminal apparatus according to said order of priority.

6. The gatekeeper apparatus as claimed in claim 5, wherein said gatekeeper apparatus estimates network load, and processes said call connection request according to the estimated network load and said order of priority.

7. The gatekeeper apparatus as claimed in claim 6, wherein said network load is estimated on the basis of a number of terminal apparatuses that are operating.

8. The gatekeeper apparatus as claimed in claim 6, wherein said network load is estimated on the basis of a total amount of bandwidths used by terminal apparatuses that are operating.

9. A communication system including a plurality of terminal apparatuses that use a packet communication network and a gatekeeper apparatus for performing call control for said plurality of apparatuses, wherein:
said gatekeeper apparatus sets a priority to at least one of said plurality of terminal apparatuses, and processes a call connection request from a terminal apparatus according to said priority.

10. A communication system including a plurality of terminal apparatuses that use a packet communication network and a gatekeeper apparatus for performing call control for said plurality of apparatuses, wherein:
said gatekeeper apparatus sets order of priority to said plurality of terminal apparatuses, and processes a call connection request from a terminal apparatus according to said order of priority.

11. A gatekeeper apparatus for performing call control for a plurality of terminal apparatuses that use a packet communication network, said gatekeeper apparatus comprising:
a storing part for storing a terminal management table, said terminal management table including priority information for at least one of said plurality of terminal apparatuses;
a receiving part for receiving a call connection request from a terminal apparatus;
a decision part for determining whether said call connection request is accepted on the basis of said priority information.

12. A gatekeeper apparatus for performing call control for a plurality of terminal apparatuses that use a packet communication network, said gatekeeper apparatus comprising:
a storing part for storing a terminal management table, said terminal management table including order of priority for said plurality of terminal apparatuses;
a receiving part for receiving a call connection request from a terminal apparatus;
a decision part for determining whether said call connection request is accepted on the basis of said order of priority.

13. A gatekeeper apparatus for performing call control for a plurality of terminal apparatuses that use a packet communication network, said gatekeeper apparatus comprising:
a storing part for storing a terminal management table;
a receiving part for receiving a call connection request from a terminal apparatus;
an estimation part for estimating network load by using said terminal management table;
a decision part for determining whether said call connection request is accepted on the basis of said network load.

14. The gatekeeper apparatus as claimed in claim 13, wherein said estimation part estimates said network load on the basis of a number of terminal apparatuses that are operating, said number being obtained from terminal information in said terminal management table.

15. The gatekeeper apparatus as claimed in claim 13, wherein said estimation part estimates said network load on the basis of a total amount of bandwidth used by terminal apparatuses that are operating, an individual bandwidth for each of said terminal apparatuses that are operating being obtained from terminal information in said terminal management table.

16. The gatekeeper apparatus as claimed in claim 13, wherein said decision part determines whether said call connection request is accepted on the basis of priority information when there does not remain enough unused network capacity, said priority information being included in said terminal management table.

17. The gatekeeper apparatus as claimed in claim 13, wherein said decision part determines whether said call connection request is accepted on the basis of an order of priority in addition to said network load, said order of priority being included in said terminal management table.

18. A gatekeeper apparatus for performing call control for a plurality of apparatuses that use a packet communication network, said gatekeeper apparatus comprising:
means for setting priority information for at least one of said plurality of terminal apparatuses; and
means for processing a call connection request from a terminal apparatus according to said priority information.

19. A gatekeeper apparatus for performing call control for a plurality of apparatuses that use a packet communication network, said gatekeeper apparatus comprising:
means for setting order of priority for said plurality of terminal apparatuses; and
means for processing a call connection request from a terminal apparatus according to said order of priority.

20. A gatekeeper apparatus for performing call control for a plurality of apparatuses that use a packet communication network, said gatekeeper apparatus comprising:
means for estimating network load caused by terminal apparatuses that are operating;
means for processing a call connection request from a terminal apparatus according to said network load.
